(19) United States
(12) Patent Application Publication
(10) Pub. No.: US 2014/0272071 A1
(43) Pub. Date: Sep. 18, 2014

(54) SURFACTANT-FREE, SUBMICRON HYDROPHOBIC DISPERSIONS AND FOOD ENHANCEMENT THEREWITH

(71) Applicant: LEADING EDGE INNOVATIONS, Branchburg, NJ (US)

(72) Inventors: JAMES MICHAEL WILMOTT, CLINTON, NJ (US); MICHAEL ALAN ROSS, NAZARETH, PA (US)

(21) Appl. No.: 13/835,642

(22) Filed: Mar. 15, 2013

(51) Int. Cl. A23D 7/005

(52) U.S. Cl. CPC A23D 7/0053
USPC 426/557; 426/641; 426/590; 426/589; 426/644; 426/622; 426/549; 426/604; 426/506; 426/618; 426/615

(57) ABSTRACT

Compositions for use in enhancing properties of food and methods of fabrication and use thereof are provided herein. For example, in one embodiment provided is an enhanced food comprising a food contacted with a substantially surfactant-free dispersion of particles of edible hydrophobic agent(s) in an aqueous fluid, wherein the average particle size of the dispersion is 100 to 999 nm, and wherein the edible hydrophobic agent(s) of the dispersion comprise about 0.01% wt to about 70% of the dispersion.

### FIELD

Embodiments of the present invention generally relate to submicron edible hydrophobic dispersions for enhancing food, including beverages.

### BACKGROUND

The current practices for combining a hydrophobic material (such as a liquid, semi-solid, or solid) with a hydrophilic liquid requires the addition of agents that change the native properties of both the hydrophobic material and the hydrophilic liquids so that they more closely resemble one another. As the properties of the two phases converge because of the additives, they have a greater propensity to be stable for a commercially viable period of time. An important class of additives that can be used in these hydrophobic phase/hydrophilic phase combinations is the surface active agent, which is typically referred to as a “surfactant”. These materials are amphiphilic, having both hydrophobic and hydrophilic properties.

When one or more of these agents are incorporated into either the hydrophobic phase or the hydrophilic phase they will align themselves at the hydrophobic phase-hydrophilic phase interface or at the interface between the composition and the surrounding air. The force that exists at the hydrophobic phase-hydrophilic phase (“Interfacial Tension”) is reduced allowing the two phases to more favorably coexist. Similarly, the force that exists at the air-composition interface (“Surface Tension”) is also reduced. A special sub-category of surfactants is called an emulsifier. When carefully selected, such emulsifiers have a wide range of surface-active properties. These materials not only lower the interfacial tension at the hydrophobic phase/hydrophilic phase interface but, with the input of shearing energy, they enable the formation of stable droplets of one phase within the other. The resulting product is called an emulsion. In many cases such emulsions are prepared by heating the hydrophobic and hydrophilic phases to a temperature of 70° C. or greater before combining the two phases. The purpose of heating the phases is to ensure that all semi-solid and solid hydrophobic materials used are melted, and that the two phases have a low enough viscosity so the two phases can mix freely. The hydrophobic and hydrophilic phases are typically mixed together until they achieve a homogeneous appearance. Thereafter, they are cooled to ensure the formation of appropriately sized droplets, which is usually in the 3 micron to 10 micron range. Such emulsions typically have a homogeneous, opaque, white appearance due to their particle size.

Although the use of surfactants in the food industry has provided many benefits, the inventors have observed that the use of surfactants to the food industry can have many deficiencies as well. For example, although the many different types of surfactants have yielded a vast array of foods and beverages with desirable properties, the inventors have observed certain undesirable issues associated with their use as well. These issues can produce thermodynamically unstable, non-reproducible and difficult-to-scale emulsions.

The time to develop a traditional emulsifier-based product is lengthy. When changes to either the aqueous phase or oil phase are made, for example due to supply issues or changing consumer preferences, the previously effective emulsifier blend generally must be altered. Such changes may undesirably result in a change in one or more aesthetic, performance, or health properties. Immediate stability of the composition is often compromised as a result and, worse, resulting instability may not be identified until the second or third month of accelerated stability testing. This can compromise the long-term shelf life of the product. Correction requires a complex, often empirical, rebalancing of the formulation.

Compounding these production and stability issues is the effect that processing can have on the outcome of a batch. Emulsion stability is dependent on a variety of parameters such as the zeta potential, particle size, crystal formation and water binding activity of the ingredients employed to achieve the desired rheological properties of the product. These parameters are dependent on the temperature to which the oil and water phases are heated, the rate of heating, the method and rate of mixing of the phases when combined at elevated temperatures, and the rate of cooling. Most emulsions require heating to ensure that all higher melting point materials, such as waxes and butters, are completely melted, dissolved or dispersed in the appropriate phase or to accelerate the hydration of starches and other thickening agents.

Some emulsions are made without heating but these systems preclude the use of higher melting point materials that can add richness to the oral aesthetics of the final product. Further, if the rate of mixing is high, there is a chance that air can be entrapped in the emulsion. This phenomenon causes an undesirable decrease in the specific gravity of the product and an increase in product viscosity. Any variability in processing can lead to a range of undesirable rheological and textural properties. This issue can occur even if the formulation is not modified. Often, if two or more formulators prepare the same product, the resulting compositions may vary considerably. This surprising variation can occur even though each person utilized the same lots of raw ingredients. The unsettling phenomenon occurs because it may be very difficult to exactly reproduce all of the processing parameters used to make an emulsion. If processing variables vary in small, difficult-to-track ways, unexpected particle size variations may occur, or the crystalline properties of the emulsion can be compromised.

Given these concerns, a typical 500-g to 2000-g lab preparation may not translate directly to a manufacturing environment. Moreover, equipment used in the laboratory generally does not well model that used in the plant. There is usually a need for an intermediate development phase during scale-up that facilitates this transition. Some equipment for this intermediate phase is engineered to mimic plant conditions but at a fraction of the size. Even so, scale-up issues abound. To deal with the vagaries of scale-up, the product may be subjected to a wide range of processing variations in order to optimize the conditions of manufacture. Products made at each level of scale-up are typically subjected to accelerated stability testing to ensure the integrity of the product for its anticipated shelf life. These issues increase the time and cost of bringing a new product into production. As a consequence, most formulators tend to stay with certain tried and true approaches of the past, thereby minimizing uniqueness and ingenuity.

Traditional emulsion systems also create difficulties in manufacturing. The need for heating and cooling systems, specialized mixing equipment, and assorted additional processing devices makes the manufacture of emulsion systems capital intensive. Further, the equipment specifications and energy requirements will vary from country to country. This situation will cause a modification in the processing variables thereby making it almost impossible to have a truly “global” manufacturing protocol. The energy needed to process such products can be costly. Similarly, there is typically a long batch processing time. It can take from 5 to 24 hours, or more, to complete the processing of emulsions depending on the batch size and number of sub-phases required. This reality requires intensive labor that adds to cost.

In the surfactant mediated process, the need for high temperature water or steam to heat the phases of the batch can cause damage to heat sensitive hydrophobic agents. Prolonged heating of certain materials can accelerate the reaction of the hydrophobic agent with other components in the emulsion, or with air. For example, unsaturated hydrocarbons, such as vegetable oils, can oxidize, which lead to rancidity or an undesirable color change. Prolonged heating can reduce the potency of hydrophobic nutritional compounds, such as vitamins and antioxidants, as well as modify flavor-providing molecules. In today's market, consumers are less accepting of non-natural stabilizing agents (such as preservatives, artificial flavors or aromas, chelating agents, and synthetic antioxidants) to address these concerns.

The presence of surfactants, preservatives, chelating agents, and other synthetic additives raises safety and health concerns in consumers. These materials are perceived to be artificial and not natural. Their inclusion creates processed food, which has been linked to obesity, diabetes, carcinogenicity, teratology, arthritis, high blood pressure, arteriosclerosis and a compromised immune system. Because of these issues there is rising regulatory pressure and pressure from consumer activists to remove such artificial agents from compositions intended for human consumption.

The presence of emulsifiers in food products as well as the super-micron particle size micelles that they form can also result in a sub-optimal taste sensation and limited textural variability creating a less enjoyable eating or drinking experience

Surfactant micelles, nanospheres, nanoparticles, nanoemulsions, nanocochleates, liposomes, nanoliposomes, and other encapsulating delivery systems have been used to address some of the issues described above. Mozafari, et. al. describe the various ways to make liposomes and nano-liposomes, which are closed, continuous, vesicular structures composed mainly of phospholipid bilayer(s) in an aqueous environment (2008, Journal of Liposomal Research 18:309-327) However, these systems contain either a specific bi-layer structure or other encapsulating techniques such as cyclodextrin entrapment or crosslinked polycarbohydrate encapsulate. Further, the surfactant micelles, nanospheres, nanoparticles and nanoemulsions contain emulsifiers that allow them to achieve their final size. In addition, these systems are all considered to be nano-technology as defined by convention and multiple regulatory agencies (less than 100 nm), giving rise to regulatory issues. There are growing health and safety concerns about the application of nano-technology in foods.

Thus, the inventors believe that what are needed are submicron dispersions of hydrophobic agent particles that are substantially surfactant free. What are further needed are submicron dispersions with a particle size that typically exceeds 100 nm in diameter. What are additionally needed are such dispersions that remain stable when diluted in aqueous fluid, and are thus much more flexibly employed in a food preparation process. What is needed is a dispersion concentrate that can be used in the same manner in a laboratory preparation, by an end user, or in a commercially-scaled preparation. What is needed is a dispersion concentrate that can be readily used in a beverage. What are needed are submicron dispersions of hydrophobic agent particles that are reproducible, and reproducibly employed if formed from a given mixture of hydrophobic agent(s) to a certain particle size specification. What are further needed are dispersions that can be made with at most limited heating. What is needed are foods combined with a submicron dispersion of hydrophobic agent, including those having improved texture, taste, nutritional value, odor, appearance, ease of preparation, or cost of production.

Thus, the inventors have provided embodiments of submicron lipid dispersions beneficial for enhancing food that overcome one or more of the problems discussed above and that provide benefits described above.

### SUMMARY

Compositions for use in enhancing properties of food and methods of fabrication and use thereof are provided herein. In one embodiment, provided is a dispersion for use in enhancing a food product, comprising: a substantially surfactant-free dispersion of particles of edible hydrophobic agent(s) in an aqueous fluid, wherein the average particle size of the dispersion is 100 to 999 nm, and wherein the edible hydrophobic agent(s) of the dispersion comprise about 0.01% wt to about 70% of the dispersion.

In another embodiment, provided is an enhanced food comprising a food contacted with a substantially surfactant-free dispersion of particles of edible hydrophobic agent(s) in an aqueous fluid, wherein the average particle size of the dispersion is 100 to 999 nm, and wherein the edible hydrophobic agent(s) of the dispersion comprise about 0.01% wt to about 70% of the dispersion.

In still another embodiment, provided is a method of enhancing food comprising contacting the food with a substantially surfactant free dispersion of particles of edible hydrophobic agent(s) in an aqueous fluid, wherein the average particle size of the dispersion is 100 to 999 nm, and wherein the edible hydrophobic agent(s) of the dispersion comprise about 0.01% wt to about 70% of the dispersion.

### BRIEF DESCRIPTION OF THE DRAWINGS

Embodiments of the present invention, briefly summarized above and discussed in greater detail below, can be understood by reference to the illustrative embodiments of the invention depicted in the appended drawings. It is to be noted, however, that the appended drawings illustrate only typical embodiments of this invention and are therefore not to be considered limiting of its scope, for the invention may admit to other equally effective embodiments.

FIG. 1 is a size distribution for a coconut oil triglycerides dispersion in accordance with some embodiments of the present invention.

FIG. 2 shows a schematic size comparison of a 150-300 nm particle of the invention vs. a 3-5 micron surfactant-based micelle.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

The direct or surfactant-mediated application of a hydrophobic material to the surface of a solid food may not allow the material to diffuse adequately into the substrate to provide a desired level of benefit. Further, it is very difficult to incorporate hydrophobic material into flour or other similar powdered substrates as the hydrophobic material is coated with the powder making it very difficult to mix uniformly into the system without high energy. The current formulation adds hydrophobic material concurrently in an intimately and uniformly mixed composition.

The dispersion of hydrophobic material of the present invention is formed mechanically, instead of with surfactants. As such, the dispersion can be formed simply of materials found abundantly in organic or naturally derived food.

A “hydrophobic agent” according to the invention has a solubility of less than about 0.1% by weight in water. Generally, the dielectric constant of a material provides a rough measure of a material's polarity. The strong polarity of water is indicated, at 20° C., by a dielectric constant of 80.10. Materials with a dielectric constant of less than 15 are generally considered to be non-polar. In embodiments, the “hydrophobic agent” component(s) are substantially non-polar, in that 90% wt or more are non-polar by this dielectric constant measure. In embodiments, 95% or 99% wt or more of the hydrophobic agent component(s) are non-polar.

Generally vapor pressure is a measure of the volatility of a material at 20° C. as compared with water whose vapor pressure is 2.3 kPa. Hydrophobic agents of the current invention with a vapor pressure less than that of water are considered to be non-volatile. In embodiments, the “hydrophobic agent” component(s) are substantially non-volatile, in that 75% wt or more are non-volatile. In embodiments, 95% or 99% wt or more of the hydrophobic agent component(s) are non-volatile.

A composition is “substantially free of surfactant” according to the invention when the amount of surfactant is not sufficient to materially lower the surface tension of an aqueous fluid, except that amphiphilic compounds with a CMC of 10̂-8 mol/L or lower can be present in amounts of 1 part weight to 5 parts weight of other hydrophobic agents, or less. In embodiments where the submicron dispersions of hydrophobic agent particles are substantially free of surfactants, the weight ratio of hydrophobic agent(s) to surfactant molecules(s) other than amphiphilic compounds with a CMC of 10̂-8 mol/L or lower is 10 or more. In embodiments, the ratio is 100 or 200 or 500 or 1000 or more. Such minor amounts of surfactants can be composed of anionic, cationic or non-ionic surfactant molecules.

An “aqueous fluid” according to the invention contains 50% wt water or more, and 0-50% solutes and water miscible solvents, such as in embodiments 75% wt water or more, and 0-25% solutes and water miscible solvents.

An “edible” material according to the invention is one that is generally recognized as safe for human or animal consumption.

“Hydrophobic agent particles” are colloidal droplets of hydrophobic agent(s), wherein at some temperature in the range of 20 to 90° C. the droplets would be liquid.

A “submicron dispersion” is defined as a suspension of hydrophobic agent particles in an aqueous fluid with an average particle size of from 100 nm to 999 nm. In embodiments of the invention, 85% or more, or 90% or more, of the hydrophobic agent particles by volume have a size within 200 nm of the average particle size. In embodiments of the invention, 85% or more, or 90% or more, of the hydrophobic agent particles by volume have a size within 150 nm of the average particle size. In embodiments of the invention, 85% or more, or 90% or more, of the hydrophobic agent particles by volume have a size within 100 nm of the average particle size. The hydrophobic agent particles are not included in the water-solvent-solute weight percentages. The submicron dispersion can be as produced by the processes described herein, or as concentrated therefrom, or as diluted therefrom.

The submicron dispersions of hydrophobic agent particles can be “contacted” with food products. The meaning of “contacted” will be understood by those of skill in the art, and includes being applied onto or into the food substrate using any commercially-viable process.

The submicron dispersions of hydrophobic agent particles can include one or more amphiphilic compounds with a CMC of 10̂-8 mol/L or lower. In certain embodiments, examples of these amphiphilic compounds include but are not limited to one or more phospholipids having a net neutral charge at pH 7.4, such as phosphatidylcholine or phosphatidylethanolamine. In certain embodiments, the amphiphilic compound(s) are for example, without limitation, one or more phospholipids having a net negative charge at pH 7.4, such as a phosphatidylinosiitide, phosphatidylglycerol, or phosphatidic acid.

The amount of phospholipid can be from 0.1% (wt) or 1% (wt) to 15% (wt), as a percentage of the total phospholipid+hydrophobic agent that is not phospholipid. Such phospholipid can contain either saturated or unsaturated fatty acyl chains. The phospholipids may be subjected to the process of hydrogenation to minimize the level of unsaturation thereby enhancing their resistance to oxidation. Exemplary sources of hydrogenated phosphatidylcholine (lecithin) include, for example, Basis LP20H lecithin from Ikeda Corp., Japan).

In optional embodiments, the submicron dispersions of hydrophobic agent compositions may be substantially free of polymeric encapsulants such as cyclodextrin in that a given submicron dispersion could be prepared with the same average particle size ±100 nm using the same composition absent the polymeric encapsulants, and be stable for a commercially viable period of time.

The dispersion of the invention may be produced by mixing an aqueous fluid and hydrophobic agents using processing conditions known in the art including but not limited to sonication (Sonic Man, Matrical Bioscience, Spokane, Wash.), high pressure/high shear (e.g., utilizing Microfluidizer, Microfluidics Company, Newton, Mass.), freeze drying (Biochima Biophys Acta 1061:297-303 (1991)), reverse phase evaporation (Microencapsulation 16:251-256 (1999)), and bubble method (J Pharm Sci 83(3):276-280).

In sonication, for example, high intensity sound waves bombard the product for predetermined period of time. In direct sonication, the sonication probe is directly applied into the composition for processing. In indirect sonication, the composition is immersed into an ultrasonic bath, where it is exposed to the processing conditions for a predetermined period of time.

Precipitation utilizes compounds that are poorly-soluble in water, but soluble in organic solvents and surfactants that are water-soluble, to create emulsions. Two separate solutions are formed, one of an organic solvent and compounds, the other a mixture of surfactant dissolved in water. The two solutions are combined and an emulsion is created. The organic solvent is then evaporated out of the emulsion, causing the small spherical particles to precipitate, creating a suspension of submicron particles.

High pressure/high shear utilizes an aqueous phase and a hydrophobic phase. The aqueous phase is prepared into a solution and any other water-soluble or water miscible components are optionally added. The hydrophobic phase is prepared into a mixture with any other non-water miscible or non-water soluble components. The two phases are pre-combined and then subjected to pressure ranging from 10K-50K psi. The composition contains submicron particles.

In freeze drying, two available methods are thin film freezing and spray freeze drying. In spray freeze drying, for example, an aqueous solution containing active ingredients is atomized into the cold gas above a cryogenic liquid. The atomized particles adsorb onto the gas-liquid interface and aggregate there as submicron particles.

The production process is adapted to obtain hydrophobic particles of the appropriate size. The substantially surfactant-free hydrophobic agent particles of the invention, which are typically mechanically created, differ from the typical micelles whose creation is dependent on surfactant. The particles of the dispersion of the invention are believed to be stable primarily due to small size, rather than surfactant effects. This stability enhancement is defined by Stokes' Law which is illustrated in an equation relating the terminal settling or rising velocity of a smooth sphere in a viscous fluid of known density and viscosity to the diameter of the sphere when subjected to a known force field. This equation is V=(2gr²)(d1-d2)/9ü, where V=velocity of fall (cm/sec), g=acceleration of gravity (cm/sec²), r=radius of particle (cm), d1=density of particle (g/cm³), d2=density of medium (g/cm³), and ü=viscosity of the medium (dyne sec/cm²). Using this equation, with all other factors being constant, a 200 nm hydrophobic agent particle has a velocity of fall that is 680 times slower than one of identical composition having a 5 micron particle size of a standard emulsion.

The composition may be produced with a shear that creates in combination with pressure an average particle size of between about 100 nm to about 999 nm, such as between about 100-500 nm, or 150-300 nm. The process can, for example, without limitation, include a rapid return to atmospheric pressure. Embodiments include wherein 85% or more, or 90% or more, of the particles by volume are within one of the above-cited ranges.

FIG. 1 shows a size distribution for a dispersion of coconut oil triglycerides as measured by a Malvern ZetaSizer particle size analyzer (Malvern Instruments Ltd. Malvern, UK) which was prepared using a Microfluidizer at 15,000-20,000 psi of pressure. This figure indicates that the mean particle size is 196.4 nm. Sizes recited herein are those determined by dynamic light scattering for spectrum analysis of Doppler shifts under Brownian Motion. Measurements are made using Mie scattering calculations for spherical particles. This reproducible methodology can be conducted with several other available instruments for measuring average particle size and particle size distribution, including instruments from Microtrac (e.g., Nanotrac instrument, Montgomeryville, Pa.) or Horiba Scientific (Edison, N.J.).

The temperature of operation is generally between about 15° C. and about 30° C. In certain embodiments, the process avoids temperatures in excess of about 50° C., or in excess of about 60° C. However certain embodiments may require a temperature exceeding 60° C. to melt the hydrophobic edible agent.

The dispersion can optionally include a rheological modifying agent. Such agents are known in the art and include, without limitation, those set forth in the following table adapted from www.foodadditives.org/food_gums/common.html:

TABLE
Rheological Agents

Agar-agar - a gum consisting of two repeating units of polysaccharides: alpha-D-
galactopyranosyl and 3,6-anhydro-alpha-L-glactopyranosyl derived from red
seaweed. Traditional agar-agar can bind approximately 100 times its weight in water
when boiled, forming a strong gel that is often used as a stabilizer or thickener. A
recent application of agar-agar is replacing gelatin as the gelling agent in dairy
products, such as yogurt. Agar-agar is a non-animal gel source which is suitable for
vegetarians and people with religious dietary restrictions (Kosher/Halal).
Alginate - is a polysaccharide, like starch and cellulose, and is derived from brown
seaweed. Alginate provides properties in processed foods and beverages such as
gelling, viscosifying, suspending and stabilizing. Alginate gelling may be achieved
using calcium under controlled conditions. It employs the combination of alginate, a
slowly soluble calcium salt and a suitable calcium sequestrant, such as a phosphate
or citrate. The process may be performed at neutral or acid pH.
Carrageenan - a water soluble gum derived from red seaweeds, such as
Eucheuma, Gigartina, and Chondrus. Carrageenan is a sulfated linear
polysaccharide of D-galactose and it has a strong negative charge, thereby allowing
it to stabilize gels or act as a thickener. Carrageenan is found in numerous products,
ranging from toothpaste to soy milk. It is used to suspend cocca solids in beverages,
for example, and can be used in meats to reduce cooking losses.
Cassia Gum - is a naturally occurring galactomannan found in the endosperm of
cassia tora and obtusifolia seeds. It is an effective thickener and stabilizer for a
broad range of food applications. Cassia gum has excellent retort stability and forms
strong synergistic gels with other hydrocolloids including carrageenan and xanthan
gum. Human food grade cassia gum is specially processed to meet rigorous purity
standards.
Cellulose Gum - Carboxymethyl Cellulose (CMC), or cellulose gum is an abundant
and natural polysaccharide found in all plants. Cellulose gum is a water-soluble gum
that is based on cellulose. Cellulose gum has been used in food products for over 50
years as a thickener and stabilizer. Typical uses are in instant beverages, where it
provides texture, baked goods, where it prevents staling, and ice-cream, where it
prevents the formation of ice-crystals that can be formed from frequent freezing and
rethawing.
Gellan Gum - a food gum that is primarily used as a gelling or thickening agent. It
can be used in fortified beverages to suspend protein, minerals, vitamins, fiber and
pulp. Gellan gum also suspends milk solids in diluted milk drinks. Gellan gum can
act as a fluid gel, having a wide range of textures, and can exist as a light pourable
gel or a thick, spreadable paste. Gellan gum is a non-animal gel source which is
suitable for vegetarians and people with religious dietary restrictions (Kosher/Halal).
Guar Gum - a carbohydrate consisting of mannose and galactose at a 2:1 ratio that
can swell in cold water. Guar gum is one of the most highly efficient water-thickening
agents available to the food industry and is widely used as a binder and volume
enhancer. Its high percentage of soluble dietary fiber (80 to 85%), means that it is
often added to bread to increase its soluble dietary fiber content. Guar gum is also
commonly used to thicken and stabilize salad dressings and sauces and help
improve moisture retention in finished baked goods.
Hydroxypropyl cellulose - cellulose is an abundant and natural polysaccharide
found in all plants. Hydroxypropyl cellulose is based on cellulose and is used in
many food products to provide good foam stability. Hydroxypropyl cellulose is
commonly found in whipped toppings where it stabilizes the foam and provides a
long lasting whipped topping with dairy-like eating quality.
Konjac Gum - a polysaccharide from a plant known as elephant yam, which is
commonly found in Asia. This gum can be used as a vegan substitute for gelatin and
other thickeners. Its texture makes it ideal for jellies because of its high viscosity.
Locust Bean Gum - also called Carob bean gum, locust bean gum is derived from
the seeds of the carob bean. Locust bean gum is used for thickening, water-binding,
and gel strengthening in a variety of foods. It has synergistic interactions with other
gums, such as xanthan or carrageenan, and can be used in applications such as
dairy, processed cream cheese, and dessert gels.
Methylcellulose and Hydroxypropyl Methylcellulose - cellulose is an abundant
and natural polysaccharide found in all plants. Methylcellulose and hydroxypropyl
methylcellulose are based on cellulose and are used in many food products to
provide texture, certain mouth feels and other desirable qualities. These gums are
commonly found in soy burgers where they add meat-like texture to the vegetable
proteins, in fried appetizers like mozzarella cheese sticks and onion rings where
they create firm texture by reducing the uptake of frying oils, and in whipped
toppings where they stabilize the foam structure to give long lasting creams.
Microcrystalline cellulose (MCC) - is a polysaccharide derived from naturally
occurring cellulose similar to that found in fruits and vegetables. MCC can be used
as a bulking agent, source of fiber and moisture regulator in processed foods. MCC
may also be co-processed with carboxymethyl cellulose (CMC) to impart shear-
thinning and heat stable properties. Additional properties in food and beverages
from MCC/CMC co-processed products include gelling, viscosifying, suspending and
stabilizing.
Pectin - a polysaccharide derived from plant material, mainly citrus fruit peels, apple
peels, or sugar beets. Pectin is widely used to impart gel formation, thickening, and
physical stability to a wide range of foods. It is mostly used in fruit-based products,
including jams, jellies, confectioneries, and fruit drinks, but is also used in dairy
applications such as drinking and spoonable yogurt.
Xanthan Gum - a highly branched polysaccharide of D-glucose, D-mannose, and D-
glucuronic acid produced via bacterial fermentation using nutrient sources.. Xanthan
gum, which is considered natural, is an excellent emulsion stabilizer in salad
dressings and sauces and also is used in bakery fillings to prevent water migration
from the filling to the pastry (which has strong water-binding properties). Xanthan
gum can often be used to improve the shelf life of a product.

The rheological modifying agent can be present in an amount from 0 to 15% wt, or 0 to 10%, or 0 to 5%, or 0 to 2%, or from 0.01% to 15% wt., or 0.01 to 10%, or 0.01 to 5%, or 0.01 to 2% Rheological modifying agents are added in particular to help immobilize the particles of edible hydrophobic agents for still longer term stability of the submicron dispersions.

Examples of edible hydrophobic agents include but are not limited to mono, di, tri, or poly alkyl (or alkenyl) esters or ethers of a di, tri, or polyhydroxy compound, such as glycerin, sorbitol or other polyol compound. Examples of such esters or ethers include but are not limited to, saturated and unsaturated, linear and branched vegetable oils, such a soybean oil, almond oil, castor oil, canola oil, cottonseed oil, grapeseed oil, rice bran oil, palm oil, coconut oil, palm kernel oil, olive oil, linseed oil, sunflower oil, safflower oil, peanut oil and corn oil. Useful saturated and unsaturated oils include those having 90% or more (molar) fatty acyl components with 6 to 30 carbon atoms, such as 6 to 24 carbons, or 12 to 24 carbons.

Examples of fatty acids providing fatty acyl components, or which provide hydrophobic agents include, without limitation, for example (from www.scientificpsychic.com/fitness/fattyacids.html):

TABLE
Common Fatty Acids

| | Carbon | Double | | |
|---|---|---|---|---|
| Common Name | Atoms | Bonds | Scientific Name | Sources |
| Butyric acid | 4 | 0 | butanoic acid | butterfat |
| Caproic Acid | 6 | 0 | hexanoic acid | butterfat |
| Caprylic Acid | 8 | 0 | octanoic acid | coconut oil |
| Capric Acid | 10 | 0 | decanoic acid | coconut oil |
| Lauric Acid | 12 | 0 | dodecanoic acid | coconut oil |
| Myristic Acid | 14 | 0 | tetradecanoic acid | palm kernel oil |
| Palmitic Acid | 16 | 0 | hexadecanoic acid | palm oil |
| Palmitoleic Acid | 16 | 1 | 9-hexadecenoic acid | animal fats |
| Stearic Acid | 18 | 0 | octadecanoic acid | animal fats |
| Oleic Acid | 18 | 1 | 9-octadecenoic acid | olive oil |
| Ricinoleic acid | 18 | 1 | 12-hydroxy-9-octadecenoic | castor oil |
| | | | acid | |
| Vaccenic Acid | 18 | 1 | 11-octadecenoic acid | butterfat |
| Linoleic Acid | 18 | 2 | 9,12-octadecadienoic acid | grape seed oil |
| Alpha-Linolenic Acid | 18 | 3 | 9,12,15-octadecatrienoic acid | flaxseed |
| (ALA) | | | | (linseed) |
| | | | | oil |
| Gamma-Linolenic | 18 | 3 | 6,9,12-octadecatrienoic acid | borage oil |
| Acid | | | | |
| (GLA) | | | | |
| Arachidic Acid | 20 | 0 | eicosanoic acid | peanut oil, |
| | | | | fish oil |
| Gadoleic Acid | 20 | 1 | 9-eicosenoic acid | fish oil |
| Arachidonic Acid | 20 | 4 | 5,8,11,14-eicosatetraenoic | liver fats |
| (AA) | | | acid | |
| EPA | 20 | 5 | 5,8,11,14,17- | fish oil |
| | | | eicosapentaenoic acid | |
| Behenic acid | 22 | 0 | docosanoic acid | rapeseed oil |
| Erucic acid | 22 | 1 | 13-docosenoic acid | rapeseed oil |
| DHA | 22 | 6 | 4,7,10,13,16,19- | fish oil |
| | | | docosahexaenoic | |
| | | | acid | |
| Lignoceric acid | 24 | 0 | tetracosanoic acid | small amounts |
| | | | | in most fats |

Fatty acyl compositions of some oils useful in the invention, reciting the rounded wt percentage of some leading natural fatty acids, include without limitation the following (from www.scientificpsychic.com/fitness/fattyacids1.html):

TABLE
Fatty Acid Compositions of Edible Hydrophobic Agents

| | | | | | | | | Poly | |
|---|---|---|---|---|---|---|---|---|---|
| | | | | | | | | unsaturated | |
| | | | | | | | Mono | | Alpha |
| | | Saturated | | | | | unsatur. | Linolenic | Linoleic |
| | Unsat./ | Capr. | Laur. | Mryis. | Palm. | Stear. | Oleic | Acid | Acid |
| | Sat. | Acid | Acid | Acid | Acid | Acid | Acid | (ω6) | (ω3) |
| Oil or Fat | ratio | C10:0 | C12:0 | C14:0 | C16:0 | C18:0 | C18:1 | C18:2 | C18:3 |
| Almond Oil | 9.7 | — | — | — | 7 | 2 | 69 | 17 | — |
| Beef Tallow | 0.9 | — | — | 3 | 24 | 19 | 43 | 3 | 1 |
| Butterfat (cow) | 0.5 | 3 | 3 | 11 | 27 | 12 | 29 | 2 | 1 |
| Butterfat (goat) | 0.5 | 7 | 3 | 9 | 25 | 12 | 27 | 3 | 1 |
| Butterfat (human) | 1.0 | 2 | 5 | 8 | 25 | 8 | 35 | 9 | 1 |
| Canola Oil | 15.7 | — | — | — | 4 | 2 | 62 | 22 | 10 |
| Cocoa Butter | 0.6 | — | — | — | 25 | 38 | 32 | 3 | — |
| Cod Liver Oil | 2.9 | — | — | 8 | 17 | — | 22 | 5 | — |
| Coconut Oil | 0.1 | 6 | 47 | 18 | 9 | 3 | 6 | 2 | — |
| Corn Oil (Maize Oil) | 6.7 | — | — | — | 11 | 2 | 28 | 58 | 1 |
| Cottonseed Oil | 2.8 | — | — | 1 | 22 | 3 | 19 | 54 | 1 |
| Flaxseed Oil | 9.0 | — | — | — | 3 | 7 | 21 | 16 | 53 |
| Grape seed Oil | 7.3 | — | — | — | 8 | 4 | 15 | 73 | — |
| Illipe | 0.6 | — | — | — | 17 | 45 | 35 | 1 | — |
| Lard (Pork fat) | 1.2 | — | — | 2 | 26 | 14 | 44 | 10 | — |
| Olive Oil | 4.6 | — | — | — | 13 | 3 | 71 | 10 | 1 |
| Palm Oil | 1.0 | — | — | 1 | 45 | 4 | 40 | 10 | — |
| Palm Olein | 1.3 | — | — | 1 | 37 | 4 | 46 | 11 | — |
| Palm Kernel Oil | 0.2 | 4 | 48 | 16 | 8 | 3 | 15 | 2 | — |
| Peanut Oil | 4.0 | — | — | — | 11 | 2 | 48 | 32 | — |
| Safflower Oil* | 10.1 | — | — | — | 7 | 2 | 13 | 78 | — |
| Sesame Oil | 6.6 | — | — | — | 9 | 4 | 41 | 45 | — |
| Shea nut | 1.1 | — | 1 | — | 4 | 39 | 44 | 5 | — |
| Soybean Oil | 5.7 | — | — | — | 11 | 4 | 24 | 54 | 7 |
| Sunflower Oil* | 7.3 | — | — | — | 7 | 5 | 19 | 68 | 1 |
| Walnut Oil | 5.3 | — | — | — | 11 | 5 | 28 | 51 | 5 |

*Not high-oleic variety

In embodiments, without limitation, about 51% wt or more of the edible hydrophobic agent(s) are one or more of the oils identified above. In embodiments, without limitation, about 51% wt or more of the edible hydrophobic agent(s) are canola oil, corn oil, cottonseed oil, flaxseed oil, grape seed oil, peanut oil, safflower oil, sesame oil, soybean oil, sunflower oil, walnut oil, olive oil, peppermint oil, orange oil or a mixture thereof.

The hydrophobic agents can be colorants, including without limitation for example annatto oil, paprika oil, chlorphyll, lycopene, carotenoids. xanthophylls or the like. The hydrophobic agents can be essential nutrients, including without limitation, vitamins such as Vitamin D and its derivatives, Vitamin A and its derivatives, Vitamin E and its derivatives, Vitamin K, Vitamin F, Vitamin P, and the like. Other such nutrients include without limitation for example lipoic acid, lycopene, phospholipids, ceramides, ubiqinone, sterols, flavonoids, cholesterol, sphingolipids, prostaglandins, docosahexaenoic acid, and the like.

The hydrophobic agents can be flavorants, such as, without limitation, terpenes, isoterpenenes, alkyl lactones, essential oils, natural oils such as vanilla, and the like. The hydrophobic agents can be aroma providers that impart aroma to or modify aroma of a food product.

The hydrophobic agents can be artificial fats, such as, without limitation, olestra (sucrose acylated with up to eight fatty acyl groups), polyglycerol fatty acid esters (e.g., R—(OCH₂—CH(OR)—CH₂O)ₙ—R, where R represents fatty acids and the average value of n is 3), and the like.

The hydrophobic agents can be present in the dispersion composition in an amount of 0.01% or 0.1% to 70%, or 5% to 50%, or 10% to 30%, by wt.

The dispersions of the invention can be formulated with high load of hydrophobic agent(s), such as 30 or 40%-70% or 30 or 40%-60%, by wt.

In embodiments, a submicron dispersion of hydrophobic agent particles is stored in concentrated form, such as 30 to 70% wt, then diluted relatively nearer to its use in contacting a food. For example, the concentrate can be diluted 1.5, 2, 5, 10, 50, 100, 200, 1000 fold or more. As such, the concentration after dilution can be, without limitation, in the range of 0.01% to less than 30% wt.

It is the small size of the dispersion particles that imparts stability. The small size minimizes the tendency of hydrophobic particles to coalesce. The commercially viable stability described above (e.g., 180 day or more) allows a useful amount of time in which to contact the dispersions with food products. FIG. 3 shows a schematic size comparison of a 150-300 nm particle of the invention vs. a 3-5 micron surfactant-based micelle. Rheological modifying agent(s) can be optionally added to further enhance long-term stability of the edible hydrophobic agent dispersions.

The stability is further manifested in that two or more distinct dispersions can be mixed without upsetting the stability of the various component hydrophobic agent particles, or a dispersion can be diluted into aqueous fluid without upsetting the stability of the component hydrophobic agent particles.

Further, if hydrophobic agent A were not compatible with hydrophobic agent B when mixed, nonetheless a dispersion of the invention of hydrophobic agent A can be mixed with a dispersion of hydrophobic agent B, since the individual particles maintain their integrity. Peppermint Oil and Oleic Acid exemplify such incompatible hydrophobic agents.

Without being bound by theory, it is anticipated that when contacted with food product all or a taste-affecting portion of the particles will be stabilized. It is anticipated that the high surface-to-mass ratio of the particles will accentuate the effect of the hydrophobic agents on taste or aroma or the like. The small size of the hydrophobic agent particles, coupled with their high surface area, is expected to provide greater penetration into food products, again accentuating the effect of the hydrophobic agents on taste or aroma or the like.

When contacted with food, the submicron dispersions of the invention can improve texture, taste, nutrition, aroma, visual properties (e.g., color), volume, moistness, moisture preservation, or the like.

The concentrated or diluted submicron dispersions of edible hydrophobic agents can be applied onto or into the food substrate using any commercially-viable process, such as those well known in the art.

For example, the submicron dispersions can be mixed into milk or milk substitutes (e.g., coconut, soy). Thus, for example, low fat milk can be supplemented with hydrophobic agent dispersions that are highly enriched in heart-healthy polyunsaturated oils. These can enhance the flavor of these milk or milk-like substances without compromising health benefits. Similarly, any number of beverages can be improved. For example, a flavored dispersion can be added to a cocktail to improve nutrition or add flavor (with the flavor for example from oil content or a particularly flavorful hydrophobic agent).

The submicron hydrophobic agent dispersions can provide flavoring for coffee, tea or the like.

When applied to flour, the submicron hydrophobic agent dispersions can provide improved flavor, or improved moisture for products baked therefrom. The dispersion can be mixed with the flour during dough preparation, or premixed.

The submicron hydrophobic agent dispersions can be utilized as marinates, where the small particles are anticipated to effectively penetrate the food product such as meat, or any other edible protein source. The ability of the hydrophobic agent dispersions to mix readily and simply with water enables the hydrophobic agent to diffuse more rapidly into the aqueous content of meat. Treated meats can include without limitation, chicken, turkey, beef, buffalo, pork, lamb, goat, fish, scallops, other seafood, or the like.

The submicron dispersions can be utilized to modify sauces, soups, for flavor, nutrition, or the like. Surprisingly, the structural integrity of the hydrophobic agent dispersions is retained even when exposed to temperatures exceeding 80° C.

The submicron dispersions can be utilized to modify any food product that is prepared by hydration, with or without heat. Accordingly, the submicron dispersions can be provided in kits sold together with such hydratable food products, or used in a method to prepare such food products. The submicron dispersions can be contacted with the food during the hydration process. Such food products include, without limitation, pastas, rice, other grains, dried fruit or vegetables (such as dried beans), drink concentrates (such as Kool-Aid or Crystal Light concentrates), or the like. The kits can include kits with freeze-dried meals, and freeze-dried meals sealed in airtight packages, such as aluminum lined packages. Freeze-dried meals include two or more distinct food types that are not comminuted together, such as meat and pasta, or two distinct vegetables.

The submicron dispersions can be utilized as meat tenderizers that include a denaturant, such as, without limitation, an acid (e.g., vinegar) or a peptidase (e.g., papain).

All ranges recited herein include ranges therebetween, and can be inclusive or exclusive of the endpoints. Optional included ranges are from integer values therebetween (or inclusive of one original endpoint), at the order of magnitude recited or the next smaller order of magnitude. For example, if the lower range value is 0.2, optional included endpoints can be 0.3, 0.4, . . . 1.1, 1.2, and the like, as well as 1, 2, 3 and the like; if the higher range is 8, optional included endpoints can be 7, 6, and the like, as well as 7.9, 7.8, and the like. One-sided boundaries, such as 3 or more, similarly include consistent boundaries (or ranges) starting at integer values at the recited order of magnitude or one lower. For example, 3 or more includes 4 or more, or 3.1 or more.

The following embodiments are intended to demonstrate the versatility of submicron hydrophobic agent dispersions. These examples can be utilized as presented or can be diluted in water or water miscible solvent to a concentration that is optimized for a given application. They can also be combined in various ratios to provide multiple benefits to the consumer.

### Example 1

A dispersion of the invention was produced from a mixture with the following composition:

| Raw Material | % |
|---|---|
| Water | 68.750% |
| Danox 3204 [#449510] | 0.050% |
| (Premier) | |
| Canola Oil (Shopright) | 20.000% |
| N/A Butter Flavor 222676A | 10.000% |
| (Flavor Solutions Inc) | |
| Basis LP-20H (phospholipid) | 1.000% |
| Phospholipon 90H | 0.200% |
| (phospholipid) | |
| Totals | 100.00% |

The dispersion can be readily mixed with naturally sourced flour to provide a butter flavor to baked goods including but not limited to bread, cookies, snacks, and pastries. It can be combined with high unsaturated and saturated hydrophobic agents to produce a butter flavored margarine. Because of the small size of the hydrophobic agent, this dispersion can readily diffuse into substrates including but not limited to: beef, pork, chicken, lamb, turkey, duck, fish, crustaceans, deer, boar, and other protein-based foods to impart a buttery taste. The large surface area of the submicron hydrophobic agent dispersion allows the butter flavor to be presented to the taste buds and receptors with high impact.

### Example 2

A dispersion of the invention was produced from a mixture with the following composition

| Raw Material | % |
|---|---|
| Miglyol 810N (triglyceride, | 15.000% |
| Sasol) | |
| Lutein Ester Crystals | 11.000% |
| (LycoRed, Prod Code | |
| 43367) | |
| Fructose Crystal (Penta, | 49.600% |
| Product Code 06-24000) | |
| Water | 13.550% |
| KLC 99.7% Glycerin, USP | 7.100% |
| Kosher | |
| Phospholipon 75 (Lipoid) | 3.750% |
| Totals | 100.00% |

The dispersion provides a composition that enables a hydrophobic nutrient, such as lutein, to be incorporated onto or into the food substrate or beverages to transform the food substrate so that it is more physiologically beneficial to the consumer.

### Example 3

A dispersion of the invention was produced from a mixture with the following composition

| Raw Material | % |
|---|---|
| Water | 48.900% |
| Peppermint Phytobasic in | 2.500% |
| PG (Bio-Botanica) Product# | |
| 3315PBPG; Lot# PS-007-023 | |
| Glycerin | 5.000% |
| Euxyl PE9010 (Schulke) | 1.000% |
| Potassium Sorbate | 0.250% |
| Sodium Benzoate | 0.250% |
| Peppermint NF (Lebermuth | 40.000% |
| Company) Item# 70-9162-23, | |
| Lot# 1209001342 | |
| Basis LP-20H | 1.500% |
| Phospholipon 90H | 0.250% |
| Keltrol CG-RD | 0.350% |
| Totals | 100.00% |

The submicron dispersion of a hydrophobic flavor oil provides a peppermint flavor. Due to its submicron particle size and large surface area, it provides a purer, more impactful mint flavor note or provides a notable cooling sensation compared with surfactant-based systems of peppermint oil. This submicron dispersion can also be used in beverages to enhance taste.

### Example 4

A dispersion of the invention was produced from a mixture with the following composition

| Raw Material | % |
|---|---|
| Water | 53.000% |
| Food Grade Canola Oil | 45.000% |
| (Restaurant Depot) | |
| Basis LP-20H | 2.000% |
| Totals | 100.00% |

The dispersion provides a canola oil composition.

### Example 5

A dispersion of the invention was produced from a mixture with the following composition

| Raw Material | % |
|---|---|
| Water | 56.080% |
| Natrox RO | 0.100% |
| Potassium Sorbate | 0.250% |
| Sodium Benzoate | 0.250% |
| Methylparaben | 0.200% |
| Propylparaben | 0.050% |
| Disodium EDTA | 0.050% |
| Puglia Extra Virgin Olive Oil | 40.000% |
| Basis LP-20H | 1.000% |
| Keltrol CG-RD | 0.350% |
| Citric Acid 30% Aq | 1.670% |
| Totals | 100.00% |

The dispersion provides a olive oil composition.

### Example 6

A dispersion of the invention was produced from a mixture with the following composition

| Raw Material | % |
|---|---|
| Water | 54.700% |
| Glycerin | 10.000% |
| Benzyl Alcohol | 1.000% |
| Vitamin E Acetate | 1.000% |
| Lipovol G | 30.000% |
| Basis LP-20H | 2.750% |
| Phospholipon 90H | 0.250% |
| Keltrol CG-RD | 0.300% |
| Totals | 100.00% |

The submicron natural oil dispersions found in examples 5, 6, and 7 enhance the flavor, appearance, texture, tenderness, and moistness of proteins. The submicron particle size enables more rapid diffusion of the oil into the meat because it can spread into the moisture already in the meat. This creates a more favorable diffusion force allowing the oil to penetrate more deeply into the protein substrate. These submicron dispersions can also be mixed with vinegar to create a stable salad dressing.

### Example 7

A dispersion of the invention was produced from a mixture with the following composition

| Raw Material | % |
|---|---|
| Water | 59.000% |
| BFT Orange Oil (Cold | 40.000% |
| Pressed) 2/25/11 | |
| Basis LP-20H | 1.000% |
| Totals | 100.00% |

The dispersion provides an orange oil composition which can be added to any beverage to impart an orange taste. The submicron dispersion can also be mixed into baked goods to impart an orange flavor to the substrate.

The invention can be further described with respect to the following exemplary embodiments:

A. An enhanced food comprising a food contacted with a substantially surfactant-free dispersion of particles of edible hydrophobic agent(s) in an aqueous fluid, wherein the average particle size of the dispersion is 100 to 999 nm, and wherein the edible hydrophobic agent(s) of the dispersion comprise about 0.1% wt to about 70% of the dispersion.

ZZ. The enhanced food of Embodiment A, wherein the dispersion comprises about 0.01% wt. to about 15% wt. of a rheological modifying agent.

B. The enhanced food of Embodiment A or ZZ, which is a meat.

C. The enhanced food of Embodiment B, wherein the meat is chicken.

D. The enhanced food of Embodiment B or C, wherein the dispersion comprises a denaturant.

E. The enhanced food of Embodiment D, wherein the meat is chicken.

E. The enhanced food of Embodiment A or ZZ, which is a beverage.

F. The enhanced food of Embodiment E, which is milk or a milk substitute.

G. The enhanced food of Embodiment A or ZZ, which is a soup or sauce.

H. The enhanced food of Embodiment A or ZZ, which is a grain flour.

I. An enhanced baked food product comprising the flour of Embodiment H.

J. The enhanced food of Embodiment A, ZZ or B-I, wherein about 85% or more by volume of the edible hydrophobic agent particles of the dispersion have a size from about 100 nm to about 999 nm.

K. The enhanced food of Embodiment A, ZZ or J, wherein the average particle size of the dispersion is about 100 nm to about 500 nm.

L. The enhanced food of Embodiment A, ZZ or J, wherein the average particle size of the dispersion is about 150 nm to about 300 nm.

N. The enhanced food of Embodiment A, ZZ, B-I, K or L, wherein about 85% or more by volume of the edible hydrophobic agent particles of the dispersion have a size from about 100 nm to about 500 nm.

O. The enhanced food of Embodiment A, ZZ, B-N, wherein the edible hydrophobic agent(s) of the dispersion comprise about 0.01% wt to about 50% wt of the dispersion.

P. The enhanced food of Embodiment A, ZZ, B-N, wherein the edible hydrophobic agent(s) of the dispersion comprise about 10% wt to about 30% wt of the dispersion.

Q. The enhanced food of Embodiment A, ZZ, B-N, wherein the edible hydrophobic agent(s) of the dispersion comprise about 30% wt to about 70% wt of the dispersion.

R. The enhanced food of Embodiment A, ZZ, B-Q, wherein about 51% wt or more of the edible hydrophobic agent(s) of the dispersion are canola oil, corn oil, cottonseed oil, flaxseed oil, grape seed oil, peanut oil, safflower oil, sesame oil, soybean oil, sunflower oil, walnut oil, olive oil or a mixture thereof.

S. A method of enhancing food comprising contacting the food with a substantially surfactant free dispersion of particles of edible hydrophobic agent(s) in an aqueous fluid, wherein the average particle size of the dispersion is 100 to 999 nm, and wherein the edible hydrophobic agent(s) of the dispersion comprise about 0.1% wt to about 70% of the dispersion.

T. The method of enhancing food of Embodiment S, wherein the dispersion comprises about 0.01% wt. to about 15% wt. of a rheological modifying agent.

U. The method of Embodiment S or T, wherein the food is chicken.

V. The method of Embodiment S or T, where the food is one adapted to be prepared by hydration, and edible hydrophobic agent dispersion is contacted with the food during hydration.

W. The method of Embodiment V, where the food is pasta.

X. The method of Embodiment V, where the food is a grain.

Y. The method of Embodiment V, where the food is a dried fruit or vegetable

Z. The method of Embodiment V, where the food is a freeze-dried meal.

AA. The method of Embodiment S-Z, comprising (a) providing a first substantially surfactant free dispersion of particles of edible hydrophobic agent(s) average particle size of the dispersion is 100 to 999 nm, wherein the edible hydrophobic agent(s) of the first dispersion comprise about 30% wt to about 70% wt of the first dispersion, (b) diluting the first dispersion to form a second dispersion of edible hydrophobic agents with average particle size of 100 to 999 nm, wherein the second dispersion is more dilute than the first, and (c) thereafter conducting the food contacting using the second dispersion.

AB. A kit comprising (a) a food is one adapted to be prepared by hydration and (b) an edible hydrophobic agent dispersion comprising: a substantially surfactant-free dispersion of particles of edible hydrophobic agent(s) in an aqueous fluid, wherein the average particle size is 100 to 999 nm, and wherein the edible hydrophobic agent(s) comprise about 0.01% wt to about 70% of the dispersion.

AC. The kit of Embodiment AB, wherein the dispersion comprises about 0.01% wt. to about 15% wt. of a rheological modifying agent.

AB. The kit of Embodiment AB or AC, where the food is pasta.

AC. The kit of Embodiment AB or AC, where the food is a grain.

AD. The kit of Embodiment AB or AC, where the food is a dried fruit or vegetable

AE. The kit of Embodiment AB or AC, where the food is a freeze-dried meal.

AF. A dispersion for use in enhancing a food product, comprising: a substantially surfactant-free dispersion of particles of edible hydrophobic agent(s) in an aqueous fluid, wherein the average particle size of the dispersion is 100 to 999 nm, and wherein the edible hydrophobic agent(s) of the dispersion comprise about 0.01% wt to about 70% of the dispersion.

AG. The food enhancing dispersion of Embodiment AF, wherein the dispersion comprises about 0.01% wt. to about 15% wt. of a rheological modifying agent.

AH. The food enhancing dispersion of Embodiment AG or AH, wherein about 85% or more by volume of the edible hydrophobic agent particles of the dispersion have a size from about 100 nm to about 999 nm.

AI. The food enhancing dispersion of Embodiment AG or AH, wherein the average particle size of the dispersion is about 100 nm to about 500 nm.

AJ. The food enhancing dispersion of Embodiment AG or AH wherein the average particle size of the dispersion is about 150 nm to about 300 nm.

AK. The food enhancing dispersion of Embodiment AG, AH, AI or AJ, wherein about 85% or more by volume of the edible hydrophobic agent particles of the dispersion have a size from about 100 nm to about 500 nm.

AL. The food enhancing dispersion of Embodiment AG, AH, AI, AJ or AK, wherein the edible hydrophobic agent(s) of the dispersion comprise about 5% wt to about 50% wt of the dispersion.

AM. The food enhancing dispersion of Embodiment AG, AH, AI, AJ or AK, wherein the edible hydrophobic agent(s) of the dispersion comprise about 10% wt to about 30% wt of the dispersion.

AN. The food enhancing dispersion of Embodiment AG, AH, AI, AJ or AK, wherein the edible hydrophobic agent(s) of the dispersion comprise about 30% wt to about 70% wt of the dispersion.

AO. The food enhancing dispersion of Embodiment AG, AH, AI, AJ, AK, AL, AM or AN, wherein about 51% wt or more of the edible hydrophobic agent(s) of the dispersion are canola oil, corn oil, cottonseed oil, flaxseed oil, grape seed oil, peanut oil, safflower oil, sesame oil, soybean oil, sunflower oil, walnut oil, olive oil or a mixture thereof.

While the foregoing is directed to embodiments of the present invention, other and further embodiments of the invention may be devised without departing from the basic scope thereof.

1. An enhanced food comprising a food contacted with a substantially surfactant-free dispersion of particles of edible hydrophobic agent(s) in an aqueous fluid, wherein the average particle size of the dispersion is 100 to 999 nm, and wherein the edible hydrophobic agent(s) of the dispersion comprise about 0.1% wt to about 70% of the dispersion.

2. The enhanced food of claim 1, wherein the dispersion comprises about 0.01% wt. to about 15% wt. of a rheological modifying agent.

3. The enhanced food of claim 1, which is a meat.

4. The enhanced food of claim 3, wherein the meat is chicken.

5. The enhanced food of claim 3, wherein the dispersion comprises a denaturant.

6. The enhanced food of claim 1, which is a beverage, soup or sauce.

7. The enhanced food of claim 1, which is a grain flour.

8. A enhanced baked food product comprising the flour of claim 7.

9. The enhanced food of claim 1, wherein about 85% or more by volume of the edible hydrophobic agent particles of the dispersion have a size from about 100 nm to about 999 nm.

10. The enhanced food of claim 1, wherein the average particle size of the dispersion is about 100 nm to about 500 nm.

11. The enhanced food of claim 1, wherein about 85% or more by volume of the edible hydrophobic agent particles of the dispersion have a size from about 100 nm to about 500 nm.

12. The enhanced food of claim 1, wherein the edible hydrophobic agent(s) of the dispersion comprise about 0.01% wt to about 50% wt of the dispersion.

13. The enhanced food of claim 1, wherein the edible hydrophobic agent(s) of the dispersion comprise about 10% wt to about 30% wt of the dispersion.

14. The enhanced food of claim 1, wherein the edible hydrophobic agent(s) of the dispersion comprise about 30% wt to about 70% wt of the dispersion.

15. A method of enhancing food comprising contacting the food with a substantially surfactant free dispersion of particles of edible hydrophobic agent(s) in an aqueous fluid, wherein the average particle size of the dispersion is 100 to 999 nm, and wherein the edible hydrophobic agent(s) of the dispersion comprise about 0.1% wt to about 70% of the dispersion.

16. The method of claim 15, wherein the food is chicken.

17. The method of claim 15, where the food is one adapted to be prepared by hydration, and edible hydrophobic agent dispersion is contacted with the food during hydration.

18. The method of claim 17, where the food is pasta, grain, dried fruit or vegetable, or freeze-dried meal.

19. The method of claim 14, comprising:
providing a first substantially surfactant free dispersion of particles of edible hydrophobic agent(s) average particle size of the dispersion is 100 to 999 nm, wherein the edible hydrophobic agent(s) of the first dispersion comprise about 30% wt to about 70% wt of the first dispersion,
diluting the first dispersion to form a second dispersion of edible hydrophobic agents with average particle size of 100 to 999 nm, wherein the second dispersion is more dilute than the first, and
thereafter conducting the food contacting using the second dispersion.

20. A kit comprising (a) a food is one adapted to be prepared by hydration and (b) an edible hydrophobic agent dispersion comprising: a substantially surfactant-free dispersion of particles of edible hydrophobic agent(s) in an aqueous fluid, wherein the average particle size by volume is 100 to 999 nm, and wherein the edible hydrophobic agent(s) comprise about 0.01% wt to about 70% of the dispersion.

21. The kit of claim 20, where the food is pasta, grain, dried fruit or vegetable, or freeze-dried meal.
